(19) United States
(12) Patent Application Publication
(10) Pub. No.: US 2026/0227965 A1
(43) Pub. Date: Aug. 6, 2026

(54) SYSTEM AND METHOD FOR SUPPORTING ARTIFICIAL INTELLIGENCE PAIR-PROGRAMMING

(71) Applicants: Soo-Jin HWANG, Busan (KR); In-Suk CHOI, Busan (KR)

(72) Inventors: Soo-Jin HWANG, Busan (KR); In-Suk CHOI, Busan (KR)

(21) Appl. No.: 19/278,073

(22) Filed: Jul. 23, 2025

(30) Foreign Application Priority Data
Feb. 5, 2025 (KR) 10-2025-0014323

(51) Int. Cl. G06F 8/35; G06F 8/20

(52) U.S. Cl. CPC G06F 8/35; G06F 8/20

(57) ABSTRACT

There is provided a system capable of effectively overcoming communication difficulty with artificial intelligence (AI). The system includes an input unit configured to design information for a program to be generated, a coding unit configured to generate the design information as programming code based on generative AI programming, and a display unit configured to perform visibility representation by representing the programming code as a structured model using an artifacts relation model (ARM). Here, the visibility means that the code generated by the AI can be represented in the form of a table or diagram.

### CROSS REFERENCE TO RELATED APPLICATION

The present application claims priority to Korean Patent Application No. 10-2025-0014323, filed Feb. 5, 2025, the entire contents of which is incorporated herein for all purposes by this reference.

### BACKGROUND OF THE INVENTION

### Field of the Invention

The present invention relates to an automatic programming performance technology, and more specifically, to a system and method for enabling pair-programming with artificial intelligence (AI) that performs programming.

In addition, the present invention relates to a system and method for enabling a person and AI to clearly communicate information for programming using an artifacts relation model (ARM), which is a model that structures code.

### Description of the Related Art

In artificial intelligence (AI) programming, when a user provides information about a program to be generated, AI programming machine generates a program according to the user's requirements based on previously learned information and programming methods.

In this case, even when the program generated by AI sufficiently accommodates the user's requirements, it is a program in an insufficient state in many cases. This is because it is very difficult for the user to clearly explain the requirements that the program should have by distinguishing between necessary requirements and unnecessary contents. In addition, AI can generate different types of programs for the same requirements depending on learned contents or programming techniques.

Accordingly, to collaborate with the AI, there are a procedure and method for gradually obtaining a perfect program through clear communication between the user and the AI, and in this case, an effective communication method is essential.

When the AI generates a program using only code without additional explanation, it is very difficult for the user to completely understand the corresponding program just like reading code written by someone else.

In addition, since the AI does not perform programming with only information limited to the requirements provided by the user, unnecessary or unfamiliar information to the user can also be included in the program. Contents including errors or problems can be included in the corresponding program, and the user cannot know whether these contents are included.

Accordingly, users who want to perfectly perform AI programming need spend a lot of time analyzing the program generated by the AI. In addition, even when the corresponding program is clearly analyzed, explaining to AI what the user wants to modify is also directly associated with work efficiency.

In particular, when multiple people collaborate to develop a large software (SW), to use AI, the program generated by AI needs to be distinguished for each task assigned to the multiple people, and a relationship between the tasks assigned to the multiple people needs to be clearly distinguished.

However, up to now, there are no effective means of expression and/or communication for these tasks.

There are two main methods to express programs and perform communication about the programs during a process of developing SW. One is a model-centric expression method, and the other is a code-centric expression method.

In a stage of determining an SW structure and designing a function, the model-centric expression method facilitates communication about the SW structure related to the macroscopic shape, and in a stage of implementing the structured SW, it is common to perform communication using the code-centric expression method only within a divided and limited range.

There are advantages and disadvantages to these expression methods, and models are advantageous and convenient for communication in terms of a macroscopic function, but have the problem of not being able to clearly specify the code being implemented. Meanwhile, performing communication using codes has the difficulty in making explanation long when performing communication because the code is composed of detailed and clear content even when the code increases slightly.

### SUMMARY OF THE INVENTION

The present invention has been proposed to solve the above problems and is directed to providing a system and method capable of effectively overcoming communication difficulty with artificial intelligence.

In addition, the present invention is directed to providing a system and method for clear communication transmission required for AI pair-programming using an artifacts relation model (ARM) that structures code and is represented by a model.

To achieve the above objects, the present invention provides a system capable of effectively overcoming communication difficulty with artificial intelligence (AI).

The system includes an input unit configured to design information for a program to be generated, a coding unit configured to generate the design information as programming code based on generative AI programming, and a display unit configured to perform visibility representation by representing the programming code as a structured model using an artifacts relation model (ARM).

In addition, the programming code is converted into a tree structure, and positions of the programming code and the tree structure are represented by a combination of numbers.

In addition, the ARM is defined as ARM={x|x=(position, name, logic, a logical condition, input data, output data, etc.)}.

In addition, the position is a position of a block composed of layers of the program, the name is a unique name assigned to the block, the block includes a logic and a logical condition, the input data is data input to the block, the output data is data output from the block, and the others include a description of the name, a description suitable for a meaning level of the corresponding block, details or additional information of a lower function, and information defining that the corresponding block is composed of lower-level code when not specified in an ARM format.

In addition, the position is represented by a combination of numbers.

In addition, the ARM is a structured model that is represented by structuring the programming code in the form of a block.

In addition, the structured model is represented in the form of a table or diagram.

In addition, in the case of the diagram form, representation of only a partial content is possible by abstracting a block, data, and a logic with characteristics designated by a user.

In addition, a content related to the code and a content unrelated to the code in the ARM format are distinguished and reflected in the programming code.

In addition, the generative AI programming uses an ARM-based relational database.

On the other hand, another embodiment of the present invention provides a method of supporting artificial intelligence (AI) pair-programming, including an operation (a) of receiving, by an input unit, design information for a program to be generated, an operation (b) of generating, by a coding unit, the design information as programming code based on generative AI programming, and an operation (c) of performing, by a display unit, visibility representation by representing the programming code as a structured model using an artifacts relation model (ARM).

### BRIEF DESCRIPTION OF THE DRAWINGS

FIG. 1 is a block diagram of a configuration of a programming artificial intelligence (AI) system according to one embodiment of the present invention.

FIG. 2 shows an example of program blocks represented in a tree structure according to one embodiment of the present invention.

FIG. 3 shows an example of a detailed table in which an ARM corresponds to C code according to one embodiment of the present invention.

FIG. 4 shows an example of programming code corresponding to the ARM shown in FIG. 3.

FIG. 5 shows an example of the ARM represented by a diagram according to one embodiment of the present invention.

### DETAILED DESCRIPTION OF THE INVENTION

Since the present invention may have various changes and various embodiments, specific embodiments are shown in the accompanying drawings and specifically described in the detail descriptions. However, it should be understood that it is not intended to limit specific embodiments, and it should be understood to include all modifications, equivalents, and substitutes included in the spirit and scope of the present invention.

Like reference numerals have been used for like components throughout the description of each drawing. Terms such as first, second, etc. may be used to describe various components, but the components should not be limited by the terms. The terms are used only for the purpose of distinguishing one component from another.

For example, a first component may be referred to as a second component, and similarly, the second component may also be referred to as the first component without departing from the scope of the present invention. The term “and/or” includes a combination of a plurality of related listed items or any of the plurality of related listed items.

Unless defined otherwise, all terms used herein, including technical or scientific terms, have the same meaning as commonly understood by those of ordinary skill in the art to which the present invention pertains.

The terms defined in a generally used dictionary should be construed as meanings that match with the meanings of the terms from the context of the related technology and are not construed as an ideal or excessively formal meaning unless clearly defined in this application.

Hereinafter, an artificial intelligence (AI) pair-programming support system and method according to one embodiment of the present invention will be described in detail with reference to the accompanying drawings.

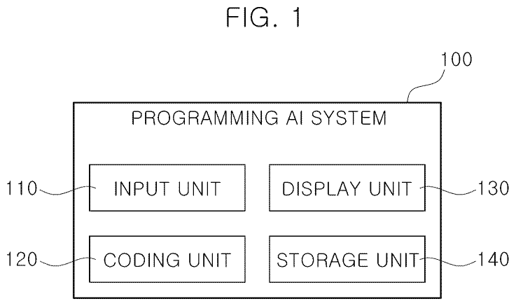

FIG. 1 is a block diagram of a configuration of a programming AI system 100 according to one embodiment of the present invention. Referring to FIG. 1, the programming AI system 100 may include an input unit 110 for receiving design information for a program to be generated, a coding unit 120 for generating programming code for the design information based on generative AI programming, a display unit 130 for displaying the programming code as a structured model using an artifacts relation model (ARM), a storage unit 140 for storing information and code related to the ARM, etc.

The input unit 110 performs a function of receiving a command of a user. Of course, the received input information may be converted into digital information. The input information may be text, but is not limited thereto, and may be voice or action. To this end, the input unit 110 may include a keyboard, a microphone, a touch screen, a camera, a digital signal processor (DSP), a communication circuit, etc.

Of course, the input unit 110 may receive the input information input by a user through a communication terminal (not shown) and a communication network (not shown).

In this case, the communication terminal (not shown) may be a smartphone, a laptop computer, a slate PC, a tablet PC, an ultrabook, a note pad, etc.

In addition, the communication network (not shown) refers to a connection structure that enables information exchange between nodes such as a plurality of terminals and servers and may be a public switched telephone network (PSTN), a public switched data network (PSDN), an integrated services digital network (ISDN), a broadband ISDM (BISDN), a local area network (LAN), a metropolitan area network (MAN), a wide LAN (WLAN), etc.

However, the present invention is not limited thereto, and the communication network may be a wireless communication network such as code division multiple access (CDMA), wideband CDMA (WCDMA), wireless broadband (Wibro), Wi-Fi, digital living network alliance (DLNA), Zigbee, Z-wave, a high speed downlink packet access (HSDPA) network, a trunked radio system (TRS), a digital trunked radio system (D-TRS), Bluetooth, radio frequency identification (RFID), infrared data association (IrDA), an ultra-wide band, a wireless universal serial bus (USB), a near field communication (NFC) network, a satellite broadcasting network, an analog broadcasting network, a digital multimedia broadcasting (DMB) network, etc. Alternatively, the communication network may be a combination of a wired communication network and a wireless communication network.

Accordingly, the input unit 110 generates design information for a program to be generated from a user or a communication terminal as input information. The design information may include program purpose, an algorithm, a use target, etc.

The coding unit 120 performs a function of generating programming code based on AI programming using the design information acquired through the input unit 110. That is, the generative AI program generates programming code in a programming language (e.g., C, C++, Python, etc.) using the design information requested by the user.

The programming code may be mainly used during a process of generating an executable program and may be a text file in which a computer program is represented by a human-readable programming language.

The display unit 130 performs visibility representation by representing the programming code as a structured model using the ARM. Of course, the display unit 130 may provide a user with a screen for inputting input information, a guidance screen for guiding the input, an execution screen for execution, etc. The display unit 130 may perform visibility representation using a liquid crystal display (LCD) device, a light-emitting diode (LED) display device, an organic LED (OLED) display device, a touch screen, a flexible display device, etc. The touch screen may also be used as an input means.

Accordingly, a user may check a currently generated program using the display unit 130 and modify and re-enter the design information using the input unit 110. Such a process is repeated to generate a final software program.

The storage unit 140 serves to store ARM-related information, code information, etc. Accordingly, the storage unit 140 may include a flash memory type, hard disk type, multimedia card micro type, and card type memory (e.g., an secure digital (SD), an extreme digital (XD) memory, etc.), a random access memory (RAM), a static random access memory (SRAM), a read only memory (ROM), an electrically erasable programmable ROM (EEPROM), a programmable ROM (PROM), a magnetic memory, a magnetic disk, an optical disk, etc. In addition, the storage unit 140 may be operate in conjunction with a web storage and a cloud server that perform a storage function on the Internet.

A method of using an ARM in AI capable of performing programming is implemented. An easy-to-understand description of the ARM is as follows.

A main feature of the ARM is a model that structures code by representing hierarchical blocks of a program in a tree structure. Here, first, the blocks are defined in detail as follows. The code is composed of a combination of blocks. The smallest unit of a block is one code line, and a program is a set of logical combinations of code lines.

For example, assuming that one program is present, the program is composed of data declarations and statements. All statements excluding those declaring data are the smallest unit of blocks. Since programming languages that do not require data declaration are present, programs coded in the corresponding programming language are composed of only blocks.

In the case of one code line, that is, x=x+1, an input is x and an output is also x. The statement is to add 1 to x and assign that value to x. Such a statement may be composed of multiple lines sequentially, and these statements are the same as blocks configured sequentially. To selectively configure a group of statements or execution of a block according to conditions, an execution logic of the block may be selectively configured, and likewise, execution conditions of the statements may be repeatedly configured.

In this way, a group of statements that is a combination of sequential/selective/repetitive statements may also become a higher-level block. In a program, the declaration of data is represented by replacing it with input/output data for blocks, and the combination of blocks represented in a tree format with a logical relationship is a configuration framework of the ARM.

Next, the ARM is defined as follows.

$$ARM = \{ x \vert x = ( position , name , logic , logical condition , input data , output data , etc . ) \}$$

The ARM is a set as defined above. That is, the ARM is a set of positions of blocks that are configured as a program hierarchy. A unique name is given to a block, and a logic and logical condition capable of executing the corresponding block are present. In addition, there are input data input to this block and output data output to the block. In addition, others may include various pieces of information related to the corresponding block. In particular, the corresponding block may include code corresponding to the block.

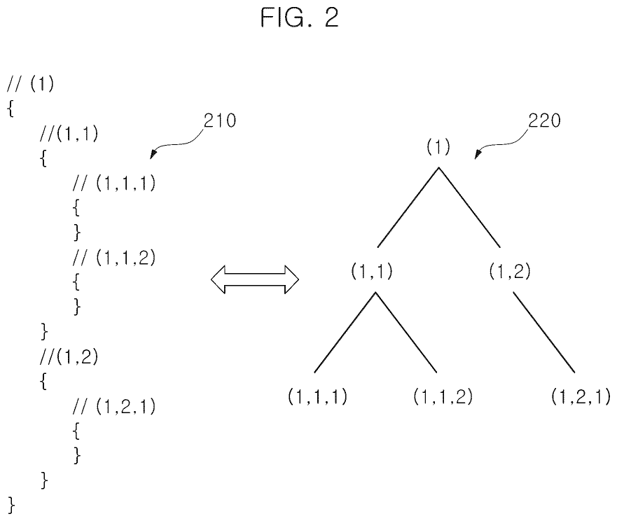

FIG. 2 shows an example of program blocks represented in a tree structure according to one embodiment of the present invention. Referring to FIG. 2, when programming code 210 is generated by the coding unit 120, the programming code 210 is converted into a tree structure 220. Locations of the programming code 210 and the tree structure 220 may be represented by a combination of numbers.

Referring to the tree structure 220, a highest-level component is (1), lowest-level components are (1,1,1), (1,1,2), and (1,2,1), and next higher-level components of the lowest-level components are (1,1) and (1,2). Both (1) and (1,1) are higher-level components of (1,1,1) and (1,1,2). (1,1,1) is sequentially ahead of (1,1,2) and is the same as the next higher-level component (1,1). The sequential position relationship is below the same next higher-level component. Accordingly, (1,1,2) and (1,2,1) are not the sequential positional relationship.

That is, each component is a lowest-level component of a lowest layer, the next higher-level component positioned adjacent to the component, a higher-level component positioned above the next higher-level component, a next lower-level component positioned adjacent to any component, a lower-level component positioned below including the next lower-level component, a highest-level component positioned above the components, and a lowest-level component positioned below the above components and distinguishes a hierarchical relationship between the components.

That is, when the blocks of the program are represented by a tree structure, the blocks become an ARM. For example, when the ARM corresponds to C code, it is as follows. Hereinafter, an example in which the code included in the ARM is C code will be described.

TABLE 1

| Components of ARM | C Code |
|---|---|
| Name | No correspondence |
| Position | Position in tree structure |
| Logic | None/If/While |
| (sequential/selective/repetitive) | |
| Conditions of logic | Conditional statement of logic |

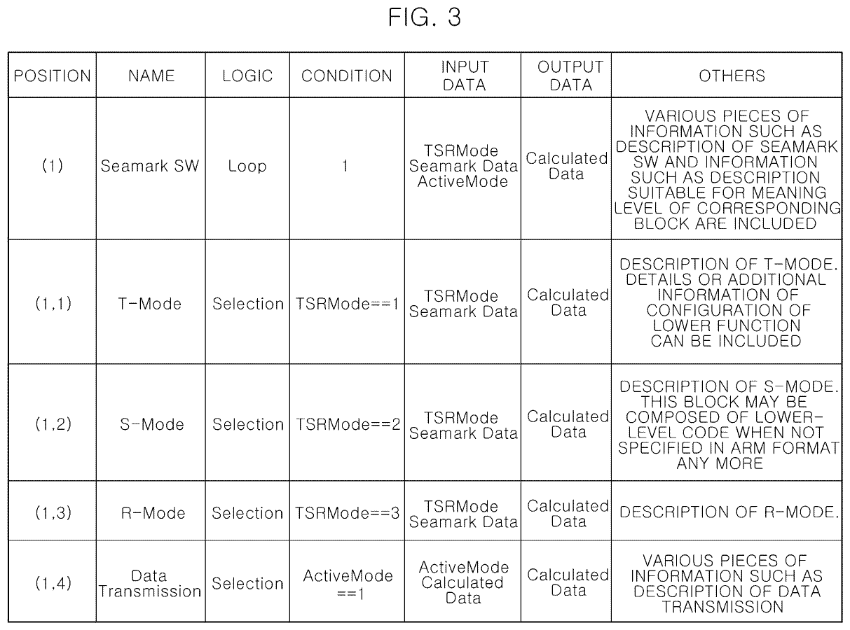

This is shown in more detail in FIG. 3.

FIG. 3 shows an example of a detailed table in which an ARM corresponds to C code according to one embodiment of the present invention. Referring to FIG. 3, position, name, logic, condition, input data, output data, etc. are configured. The name is given a unique name according to each position. For example, it is as follows.
(1): Seamark SW
(1,1): T-mode
(1,2): S-mode
(1,3): R-mode

Modes such as a T-mode, an S-mode, an R-mode, etc. are examples to show that ARM may structurally represent code. Several functions (blocks) may be configured in each mode, and specific blocks have been omitted currently. Codes that are similar but differentiated for each mode are configured in each mode.

In addition, the Seamark program is composed of tactic/simulation/record modes in which the tactic mode is a general usage mode, the simulation mode is a user training mode using virtual data, and the record mode is a mode for checking contents recorded in the general mode.

### (1,4): Data Transmission

A logic is loop and selection.

A condition is 1, TSRMode==1, TSRMode=2, TSRMode=1, and ActiveMode=1 The condition is a condition under which a block of a corresponding layer is executed in an ARM. The condition is a condition used when configuring a logical combination between blocks using the IF or WHILE statement. In FIG. 3, the condition of the T-mode block is TSRMode-1, which means that the corresponding block is executed when a value of TSRMode is 1. However, the reason why symbol “=” is used is that a logical determination representation in the C code is =.

The input data is composed of a combination of TSRMode, Seamark Data, and ActiveMode in FIG. 3, which means data required for the execution of the corresponding block. In a case in which data output from a certain block needs to be used in the block, since an output relationship may be represented from the output block toward a higher-level block, and then an input relationship may also be represented toward a lower-level block, the corresponding output data may be represented by the input data being used.

The output data is calculated data output according to the result of the logic in FIG. 3. In order for the output data of the corresponding block to be used in another block, as described above, the output data needs to be represented by output data of a higher-level block, and then also represented by input data from the higher-level block that includes the corresponding block. This is the same concept as a data flow between blocks in the code.

Others may include various pieces of information such as descriptions of names (Seamark SW, a T-mode, an S-mode, an R-mode, Data Transmission), the description of a meaning level of the corresponding block (or indicated as a block), and details or additional information such as a configuration of a lower function. In addition, when the block is no longer specified in an ARM format, the block may be assigned as a bundle or piece of code to the corresponding block. This means that the code is no longer represented by an ARM, but is left as is.

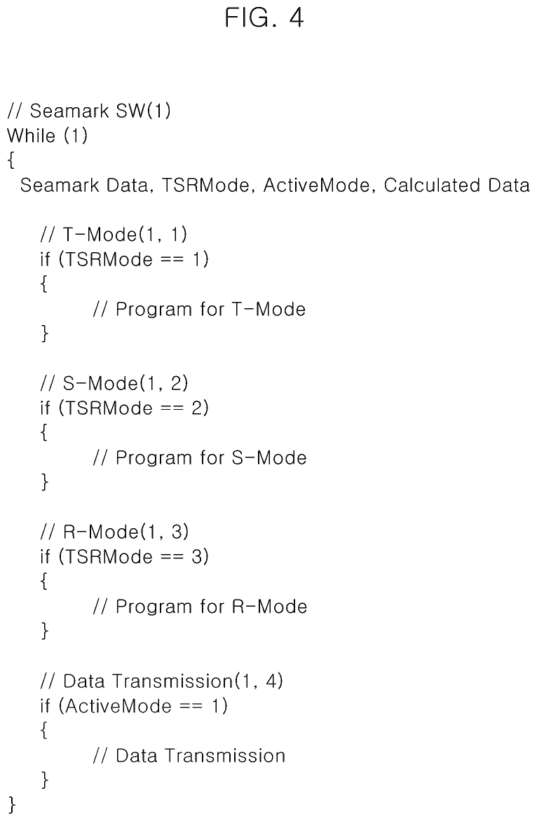

FIG. 4 shows an example of programming code corresponding to the ARM shown in FIG. 3. Referring to FIG. 4, the programming code can be easily inferred through the C code correspondence table shown in FIG. 3.

Referring to FIG. 4, reviewing original code, an ARM is a set of hierarchical blocks, and each component includes major block information. Higher-level blocks represent a grouping relationship with lower-level blocks, and the lowest-level block has one code assigned to the corresponding block.

This is the same as the above definition of block. That is, a block composed of a combination of blocks represents a structure of blocks and represents information about which blocks are assigned to the corresponding block.

The higher-level blocks may include logical relationships, conditions, input/output data, etc. between higher-level blocks, and one code, which is the lowest-level block, may be composed only of input/output data and code.

A name corresponding to the meaning may be given to each abstraction level of the block. For example, there may be a Seamark program, which is the entire program, and a T-mode, which is a mode of this program. Under the T-mode, there may be blocks for receiving Seamark data, calculating a distance between the Seamarks, displaying Seamark data on a screen, etc.

Of course, blocks (functions) with more specific names may be presented under the corresponding block. Since the input/output of data means that data required by a lower-level block is transmitted to a lower-level block through a higher-level block, data that is an input in the lower block will also be configured as input data in the higher-level block.

When the block to be ultimately transferred belongs to another block among higher-level blocks, to move to the corresponding block, the output data needs to move to a higher-level block and become input data of another block. An ARM represents the movement of the corresponding data as input/output data between blocks.

The basic information that constitutes the ARM, such as a position, a name, a logic, a logical condition, code, and other descriptions or indexes, are descriptions or supplementary data for functions assigned to the corresponding block. A block is defined to perform a certain role in the entire program, and the description or index of the corresponding block is also a factor representing such meaning.

In addition, it can be seen that code that may be included in the block may be recorded in others. That is, it can be seen that the ARM is a structured model that is represented by structuring code in the form of a block.

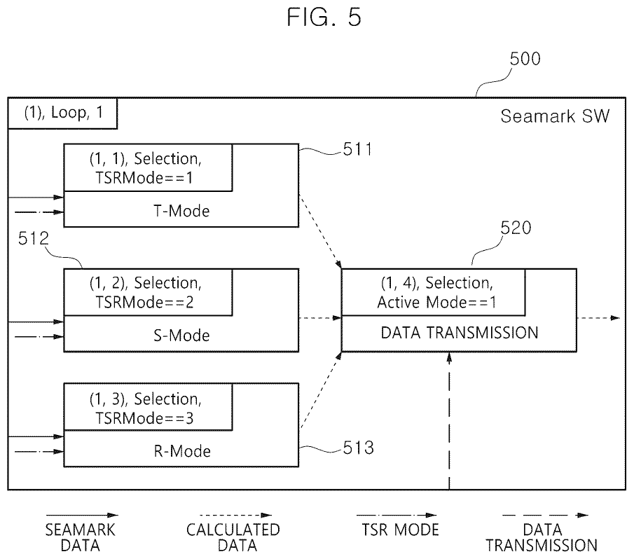

Such a structured model may also be represented by a diagram. This is shown in FIG. 5. FIG. 5 shows an example of the ARM represented by a diagram according to one embodiment of the present invention. Referring to FIG. 5, a program 500 named SeamarkSW includes a T-mode 511, an S-mode 512, an R-mode 513, data transmission 520, etc.

The table of FIG. 3 shows the most basic information and may include all pieces of information. The all pieces of information are represented in the form of a table and stored, ARM, and in the case of the program of FIG. 4, all programs or a program of some blocks designated by the user may be output on a screen when the user wants to check the information.

Of course, FIG. 3 may also be represented when the user wants to check all data. Like an excel table, only necessary information may be seen through sorting under various conditions.

The diagram in FIG. 5 represents all pieces of information by simplifying current program information, but in reality, representing all pieces of information on one screen with a diagram can be limited. This is because readability is reduced when there are too many objects. Accordingly, when configuring a diagram, the user may selectively configure information of a diagram the user wants to view just like sorting in a table.

For example, a diagram may be composed of only blocks related to the corresponding data so that only the flow of one data may be shown, or a diagram that may check the configuration of a macroscopic function by excluding all data and configuring only blocks from the highest-level to the two lower-levels.

Since the ARM may represent the programming code shown in FIG. 4 in the form of a table or diagram, clear communication about the macroscopic function is possible just like using a model. In addition, since the ARM also includes code corresponding to each component of the model, it is effective for specific communication just like using code.

A diagram includes the meaning of code configured as an example and is a representation equivalent to a table. That is, since the ARM may structure code and add various pieces of information to blocks to configure the blocks as a table and may also abstract such information to configure the information in the form of a diagram, it is useful as not only a database (DB) that comprehensively stores data but also a visual model.

In order for AI to use the ARM, the following functions are configured in a typical programming AI.

(1) AI may represent a program being generated in an ARM format. That is, a user may communicate with typical programming AI in various ways, and the AI may represent the results in an ARM format. That is, since the ARM is the same as configuring sequential, selective, and repetitive blocks in the code in a tree format, any type of program may also be represented in the corresponding ARM format.

Of course, in this case, the AI may distinguish between an ARM that configures a program and information that is not this case and configure the results. That is, information that configures the code and descriptive information that is not the code may be stored separately. As shown in the exemplary table of FIG. 3, since the ARM may represent various pieces of information required for SW development in a relational manner, the AI may configure an ARM-based relational database for the corresponding SW development.

As described above, the code is structured into blocks of several layers, and the ARM is configured in the form of a table (ARM) by relating these structures with position, logic, and logical conditions. As shown in FIG. 3, the relationships between the Seamark, the T-mode, etc. may be inferred from their names, but the relationship between higher-level and lower-level blocks, which is the affiliated relationship, can be clearly identified by their positions, and when the Seamark is executed, the condition for entering a T-mode can also be clearly identified by a conditional expression of an ARM.

Accordingly, the Seamark and the T-mode are not a linguistic relationship, but have the same relationship as the logic of the formula or code and a clear relationship. The same goes for supplementary descriptions. The descriptions added to the corresponding block is made according to the abstraction level of the corresponding block, and such a description includes the description of a lower-level block thereof. Accordingly, information represented by an ARM is clearly related by position, logic, and logical conditions like a program.

\textcircled{2} AI may represent various forms requested by a user in an ARM format. That is, it means that, even when the AI configures a program in an ARM format, the AI may provide a method of representing information by condensing the information into a format desired by the user.

The ARM may represent various pieces of information in a relational manner like a database for a program, but it can be inefficient for the user to always review all pieces of information in detail.

Accordingly, information may be configured by extracting only the information required by the user from the entire ARM. For example, in the exemplary diagram shown in FIG. 5, a diagram that only displays data input/output (i.e., input data, output data) between the same layers may be configured, or a block may be configured for the flow of specific data.

The diagram may be composed of only some features of the ARM. For example, the diagram may be composed of only blocks of two higher-level layers, excluding all data. In this case, a diagram that checks the configuration of a macroscopic function will be provided.

In FIG. 3, when the diagram is composed of the highest-level block in which TSRMode data is configured as input data, a diagram that identifies a relationship between blocks in which functions are configured may be configured using TSRMode data.

Alternatively, such a function also includes extracting code that configures a specific block. The higher-level blocks represent a combination relationship of lower-level blocks, and one code is configured only in the lowest-level block. For example, when each mode of FIG. 3 is divided into a task range for collaboration between multiple people, the relationship for each mode, that is, the logical relationship and input/output data, is defined, and thus each worker may configure details for each mode based on the corresponding information.

Extracting the code of the specific block is also the same. When the corresponding block is selected, all codes included in a lower-level of the block may be extracted. This may be used in terms of reuse, and since the code for measuring time may be used in various tasks or projects and a block in which this function is implemented can be easily identified through an ARM, the corresponding code may be extracted.

\textcircled{3} AI may distinguish between an ARM and non-ARM information that includes general languages among design information for a program to be generated received from a user and reflect the above result in programming results. That is, in an ARM format, a content related to the code and a content unrelated to the code may be distinguished and reflected in the programming code.

In general, commercialized AI is mainly based on a large language model (LLM) because there are few errors. The commercialized Als break down language while communicating with people, interpret the meaning with their own algorithms, and execute it, which can lead to misunderstandings (incorrect execution). Modifying ARM information simply means changing something from something to something rather than asking AI to paraphrase and execute the information. Accordingly, general communication and ARM modification should be distinguished. That is, it means that a method of performing communication to enable direct ARM modification rather than modifying the content of the ARM with the algorithm of AI needs to be provided.

That is, when a user clearly performs communication using an ARM, the content of the program can be directly changed.

For example, it is assumed that a task that adds “a-1” to a condition of an S-mode block is performed. Then, in typical AI, it would be tedious for a user to clearly point out the corresponding block, and thus the meaning and context of “a-1” need to be explained.

However, using the ARM, AI can freely perform programming, and the user may also perform pair-programming with the AI even when clearly modifying a part of the program. Of course, this does not typically exclude a means of communication for AI programming. It is possible to use typical AI programming methods and programming methods using an ARM at the same time.

In addition, the operations of the method or algorithm described in relation to the embodiments disclosed herein may be implemented in the form of program commands that may be executed through various computer devices such as a microprocessor, a processor, a CPU, etc. and stored in a computer-readable medium. The computer-readable recording medium may include program (command) codes, data files, data structures, etc. alone or in combination.

The program commands recorded on the medium may be specially designed and configured for the present invention or may be known and available to those skilled in the art of computer software. Examples of the computer-readable recording media may include magnetic media such as hard disks, floppy disks, magnetic tapes, etc.; optical media such as CD-ROMs, DVDs, Blu-rays, etc.; and semiconductor memory devices specifically configured to store and execute program (command) codes, such as read only memories (ROMs), random access memories (RAMs), flash memories, etc.

Here, examples of the program commands include not only machine language code such as that produced by a compiler, but also a high-level language code that may be executed by a computer using an interpreter or the like. The above hardware device may be configured to operate as one or more software modules to perform the operation of the present invention and vice versa.

According to the present invention, gradual program development is possible through mutual communication between AI and people. For example, the user can explain the macroscopic program structure to the AI, and when the corresponding ARM is completed, the user can designate components of the ARM to gradually define the functions that the components need to constitute.

In addition, when the structure of the program generated by the AI is represented in an ARM format, visibility is improved because code is represented by a model in the form of a table and a diagram. Since the user can understand the structure of the code generated by the AI and check details efficiently, it is easy to distinguish between contents to be removed and contents to be added, and information about this can gradually communicate with AI to make corrections.

In addition, AI-based programming is possible through pair-programming with multiple people. Since the ARM defines input/output data for each block and represents the logical relationship between blocks, it is possible to assign tasks to people in charge for each block, and the contact points of the tasks therebetween can be clearly defined.

Accordingly, assuming that one SW is composed of three main functions as shown in the example, it is possible to assign tasks to different people for each function, perform programming using AI individually, and integrate them later.

In addition, parallel programming using multiple Als is possible. The parallel AI programming can be required to overcome time restrictions for large-scale programming. Alternatively, programming using multiple Als in different fields can be required.

In addition to the above collaboration between multiple people, collaboration between multiple Als in various fields is also possible in AI programming capable of communication using ARM. This is also because the ARM can clearly define data and the logical relationship between tasks.

What is claimed is:

1. A system for supporting artificial intelligence (AI) pair-programming, comprising:
an input unit configured to design information for a program to be generated;
a coding unit configured to generate the design information as programming code based on generative AI programming; and
a display unit configured to perform visibility representation by representing the programming code as a structured model using an artifacts relation model (ARM).

2. The system of claim 1, wherein the programming code is converted into a tree structure, and positions of the programming code and the tree structure are represented by a combination of numbers.

3. The system of claim 1, wherein the ARM is defined as ARM={x|x=(position, name, logic, a logical condition, input data, output data, etc.)}.

4. The system of claim 3, wherein the position is a position of a block composed of layers of the program, the name is a unique name assigned to the block, the block includes a logic and a logical condition, the input data is data input to the block, the output data is data output from the block, and the others include a description of the name, a description suitable for a meaning level of the corresponding block, details or additional information of a lower function, and information defining that the corresponding block is composed of lower-level code when not specified in an ARM format.

5. The system of claim 3, wherein the position is represented by a combination of numbers.

6. The system of claim 1, wherein the ARM is a structured model that is represented by structuring the programming code in the form of a block.

7. The system of claim 6, wherein the structured model is represented in the form of a table or diagram.

8. The system of claim 7, wherein, in the case of the diagram form, representation of only a partial content is possible by abstracting a block, data, and a logic with characteristics designated by a user.

9. The system of claim 1, wherein a content related to the code and a content unrelated to the code in the ARM format are distinguished and reflected in the programming code.

10. The system of claim 1, wherein the generative AI programming uses an ARM-based relational database.

11. A method of supporting artificial intelligence (AI) pair-programming, comprising:
receiving, by an input unit, design information for a program to be generated;
generating, by a coding unit, the design information as programming code based on generative AI programming; and
of performing, by a display unit, visibility representation by representing the programming code as a structured model using an artifacts relation model (ARM).
